(19) United States
(12) Patent Application Publication
(10) Pub. No.: US 2004/0111335 A1
(43) Pub. Date: Jun. 10, 2004

(54) RFID space monitoring and asset inventory system

(76) Inventors: Charles Ronald Black, Ellicott City, MD (US); Neil Edward Amrhein, Jarrettsville, MD (US)

Correspondence Address: Sonya C. Harris, Agent for Applicant, PO Box 2607, Fairfax, VA, 22031, US

(21) Appl. No.: 10/309,093

(22) Filed: Dec. 4, 2002

(51) Int. Cl. G06F 17/60

(52) U.S. Cl. 705/28

(57) ABSTRACT

Radio frequency tags having RFID elements are located in or on items situated in a given area of interest, and an antenna is automatically and virtually continuously moved around the proximity of the items to interrogate the presence of the items. When the RFID tags are interrogated by an RFID interrogation source, that source is then quickly able to gain information as to the presence or absence of the item, and the identity of the item, for comparison to a database. Thus, inventory can be conducted continuously, which is particularly useful in the sale of high priced items, (e.g., jewelry, automobiles) or voluminous items (e.g., library or apparel articles). The antenna assembly is automatically moved throughout all of the given area of interest, thereby a group of items may be read or scanned quickly in one operation using the mobile antenna. This enables a user to conduct continuous, unattended tracking and inventory of items. Thus, an operator can determine in real time what items are stored, sold, moved or displayed, etc., which would greatly simplify inventory assessments and reduce theft.

### FIELD OF THE INVENTION

The present invention relates to radio frequency identification systems, and in particular, to a method and apparatus for monitoring certain radio frequency identification devices, within a defined space, via an automatically moving antenna.

### BACKGROUND OF THE INVENTION

Proximity detection systems or electronic article surveillance (“EAS”) systems detect the presence of small electronic devices placed on or in an article or carried by a person of interest, and are often used in retail or library environments to deter theft or other unauthorized removal of articles. These electronic devices are commonly known as tags. Information can be obtained by electronically interrogating the tag, either intermittently or continuously as a tag is moved into the field of interrogation.

Many users of EAS systems desire to know more than just whether any tagged object is present. They also want to know which tagged object is present, for example. Detailed information regarding the characteristics of objects, such as their date of manufacture, inventory status, and owner have generally been communicated to automated handling and control systems through optical bar codes. While inexpensive and effective, the optical bar code system has certain limitations.

More recently, electronic identification (also known as radio frequency identification or RFID) techniques have been developed to address the limitations of optical barcodes. RFID systems have succeeded in providing object identification and tracking. The security deficiency associated with radio frequency tags arises because they can be “shielded” by, for example, covering the tag with a hand or aluminum foil, or even placing the tag in a book. Also, because the RF pattern extending from an antenna is not perfectly shaped (spherical or hemispherical), and its shape is affected by other materials within relatively close proximity, objects tagged with an RFID tag may escape detection, either inadvertently or intentionally. This greatly reduces RFID tags detectability and thus their effectiveness.

In considering the use of RFID devices for applications identifying items, such as in inventory control, asset management, and the like, a problem arises. For example, if a number of articles, each identified by a RFID device, are stored in close proximity, such as on a group of shelves in a warehouse or supermarket, then generally energizing the areas surrounding the RFID devices will result in numerous RFID devices responding. This may or may not be desirable. Of course, an anti-collision protocol for electronically selecting a particular tag or group of devices somewhat alleviates the problem. However, this solution adds overhead and attendant cost.

Therefore, a need exists for a reliable solution for consistently identifying stationary items within a defined space or that also incurs less cost than conventional system.

### DESCRIPTION OF THE PRIOR ART

U.S. Pat. No. 6,335,686, issued to Goff, et. al, on Jan. 1, 2002, presents an Application for a radio Frequency Identification System. The Goff patent solves the problems of security deficiencies associated with RF tags due to sheilding by including a magnetic component. This component is a magnetically responsive element that may be used within a specified interrogation zone to detect unauthorized removal of tagged items.

U.S. Patent to Garber et al, U.S. Pat. No. 6,424,262, issued on Jul. 23, 2002, also directed toward Applications for Radio Frequency Identification Systems. The disclosed system relates to the use of handheld RFID devices used in connection with particular items associated with an RFID tag. Herein the system broadly employs the use of a magnetic recorded media (for enhanced security), an optical scanner, an RFID interrogation source, and a computer. The hand-held RFID device is used to quickly and rapidly survey a shelved item, such as a library book. This patent teaches of an RFID system implemented as an inventory-type system for a library environment. The hand-held device, housing the interrogation source, is manually swiped past RFID tagged items for location and inventory purposes. The further magnetic component ensures that tagged items are not removed from a specified area.

Bowers et al, (U.S. Pat. No. 6,195,006) was issued a patent on Feb. 27, 2001, for an Inventory System Using Articles with RFID Tags. This patent also discloses an application in a library environment wherein articles, such as books, have RFID tags attached to them. Each tag has a unique identification number, which is stored in a database for tracking the articles and maintaining circulation status. The shelves are periodically scanned with a mobile RFID scanner for updating inventory.

The U.S. Patent to Vega, et al., (U.S. Pat. No. 6,040,773) issued on Mar. 21, 2000, for a Radio Frequency Identification Tag Arranged for Magnetically Storing Tag State Information teaches of a RFID tag system that includes stored tag information. Herein an active tag configuration is employed wherein an antenna element receives an exciter signal from an external exciter to then energize the tag thereby causing it to generate a read signal to a nearby reader. The reader then detects the stored tag information.

In the U.S. Patent to Mon, issued as U.S. Pat. No. 6,354,493, on Mar. 12, 2002, there is disclosed a System and Method for Finding a Specific RFID tagged Article Located in a Plurality of RFID Tagged Articles. Mon teaches particularly of a method for operator feedback when utilizing an RFID reader to find specific tagged articles. Specific search criteria associated with a desired article are entered into the RFID reader. The RFID reader sends out an interrogation signal to the RFID tags. The tagged items with the specified criteria respond with the desired tag data. A processor compares the number of RFID tags matching the search criteria to the total number of RFID tags received.

Collins, et al., in U.S. Pat. No. 6,392,544, issued May 21, 2002, disclose a Method and Apparatus for Selectively Activating Radio Frequency Identification Tags that are in Close Proximity. A plurality of antenna elements are used in conjunction with an RF ID exciter. The antenna elements are spaced to define active areas. The RFID device/tag is located between the antenna elements and are capacitively powered by the electric field, allowing the tag to perform its function of exchanging data with the exciter.

The patent to Duan, et al., issued on Jun. 4, 2002, as U.S. Pat. No. 6,400,274, teaches of the concept of increasing mobility of a RFID tag by using a high-performance mobile power antennas instead of battery tags. This patent discloses power antennas that include half-wave rectifier, full wave rectifiers and voltage multipliers that are cascaded to boost the power voltage gain. Adding planar elements to increase efficiency without decreasing mobility is taught.

None of the above inventions and patents, taken either singly or in combination, is seen to describe the instant invention as claimed. The prior art fails to teach of providing a defined space with RFID tagged items situated within the defined space and providing a mechanically and automatically mobile antenna device capable of reading every tag while obviating the problems of blind spots.

### SUMMARY OF THE INVENTION

The present invention is directed toward space monitoring systems with RFID devices. For example, RFID devices are frequently used in applications identifying things, such as electronic animal identification, baggage tracking, parcel tracking, inventory management applications, asset identification and tracking, and other applications.

Many applications exist in which it is important to know whether tagged items are present or absent within a defined space where these items are typically not moving relative to the space. Some examples are display cases, shelves stocked with merchandise, assets on display within a room or on a lot outdoors. Inventory control, asset control, and security control are some potential commercial applications. To accurately and effectively take attendance of tagged items within the defined space, every tagged item must consistently respond when interrogated.

In the preferred embodiment, tags having RFID elements are located in or on items in a given area of interest, (the defined space) and a mobile antenna is continuously moved around the proximity of the items to interrogate and report the presence of the items. When the RFID tags are interrogated by an RFID interrogation source, that source is then quickly able to gain information as to the presence of the item, and the identity of the item. Thus, inventory can be conducted continuously, which is particularly useful in the tracking of high priced items, (e.g., jewelry, automobiles) or to continuously track voluminous items (e.g., library or apparel articles).

The antenna is moved throughout all of the given area of interest. Rather than use a handheld scanner that passes by individual items one after each other, a group of items may be read or scanned quickly in one operation using the mobile antenna. This enables a user to conduct continuous, unattended tracking and inventory of items. Thus, an operator can determine in real time what items are stored, sold, moved or displayed, etc., which would greatly simplify inventory assessments and reduce theft.

However, because the radio-frequency (RF) pattern extending from the antenna is not a perfectly shaped sphere or hemisphere, and its shape is affected by other material within relatively close proximity, tags which may appear to be within the antenna pattern and which could reasonably be expected to be read might in fact not be read at all. Additionally, because the shape of the antenna pattern is more or less always changing as environmental elements (electrical noise, plants, humans and other animals, humidity, metal objects, high carbon content materials, among others) are introduced and removed from the area proximate to the antenna, a tag once read at a point in time may not be read at all at another point in time. This phenomenon makes reliably reading a set of tags placed within a manufacturer-specified, normal antennas' pattern impossible to achieve.

Accordingly, it is a principal object of the invention to provide a system that accurately monitors volumes of tagged articles via a more or less continuously moving, antenna.

It is another object of the invention to employ the use of an RFID antenna mounted in a mechanism that provides non-coupled sway motion so as to continuously interrogate all RFID tags in a defined space.

It is an additional object of the invention to provide an RFID space monitoring and asset inventory system providing increased antenna coverage beyond the antenna's designed specifications and reducing the effect of antenna blind spots, and any natural, designed, or environmental inefficiencies.

An additional object of the invention is to provide an RFID space monitoring and asset inventory system that avoids the need for using a plurality of stationary antennas for monitoring a defined space thus avoiding antenna multiplexing combinations that may interfere with one another thus degrading volume performance.

It is another object of the invention to provide a space monitoring system that is scalable to different volumes of spaces being monitored.

It is a further object of the invention to provide an RF identification space monitoring system that can provide constant, real-time inventory information regarding sales effort tracking.

Still another object of the invention is to provide an electronic article surveillance system that facilitates security efforts by enhancing real-time monitoring of tagged items, thus reducing losses.

An additional object of the invention is to provide an electronic article surveillance system that provides an efficient, economically feasible alternative to other security and marketing strategies.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

Various other objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a schematic diagram illustrating the overall RFID space monitoring specification system.

FIG. 2 is a pictorial view of the tag assembly.

FIGS. 3A and 3B are a schematic diagrams illustrating the antenna movement means.

FIG. 4 is schematic illustrating operation of the RFID space monitoring and asset inventory system.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

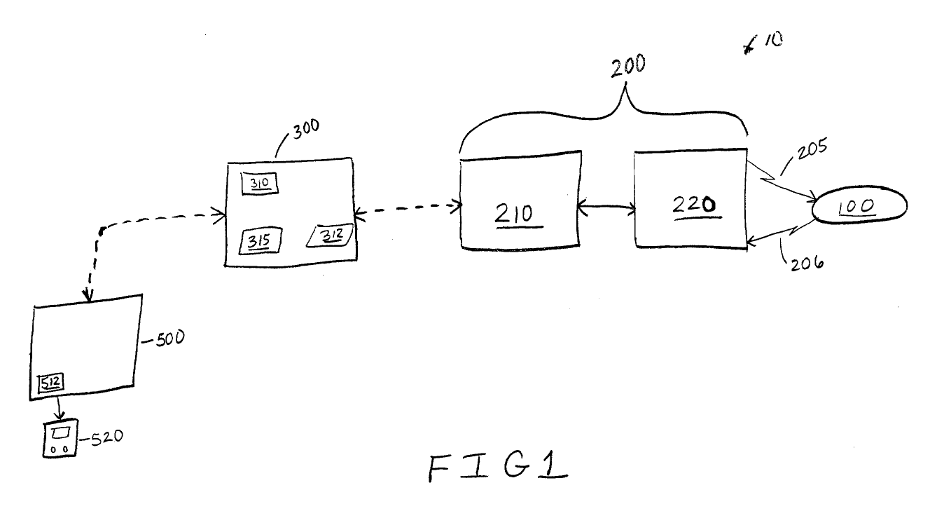

The preferred RFID space monitoring and asset inventory system 10, shown in FIGS. 1-4, is comprised of four major components. These components are:

1) the tag assemblies 100,

2) the interrogation assembly 200,

3) means for moving the antenna 400, and

4) tagged articles 150.

The system 10 is configured to obtain information from and about articles having RFID elements, which may be incorporated therein and also referred to as RFID tag assemblies 100. The tag assemblies 100 may be located anywhere on the item. Tag assemblies 100 do not have to be within the direct line of sight of the antenna 220.

As is well known in the art, RFID tags can be either active or passive. An active tag incorporates an additional energy source, such as a battery, into the tag construction. This energy source permits active RFID tags to create and transmit strong response signals even in regions where the interrogating radio frequency field is weak, and thus an active RFID tag can be detected at greater range. However, the relatively short lifetime of the battery limits the useful life of the tag. In addition, the battery adds to the size and cost of the tag making it inappropriate for many applications.

A passive tag derives its energy from the interrogating radio frequency field, and uses that energy to transmit response codes by modulating the impedance the antenna presents to the interrogating field, thereby modulating the signal reflected back to the reader antenna. Thus, their range is more limited. Because passive tags are preferred for many applications, the remainder of the discussion will be confined to this class of tags. Those skilled in the art, however, will recognize that these two types of tags share many features and that either can be used with this invention.

The antenna geometry and properties depend on the desired operating frequency of the RFID portion of the tag. For example, 2.45 GHz (or similar) Tag assemblies 100 would typically include a dipole antenna, such as a linear dipole antenna, or a folded dipole antenna. A 13.56 MHz (or similar) RFID tag would use a spiral or coil antenna. In either ease, the antenna intercepts the radio frequency energy radiated by an interrogation source. This signal energy carries both power and commands to the tag.

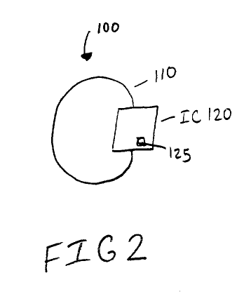

As shown in FIG. 2, a tag assembly 100 is illustrated having a coil antenna 110 coupled to an integrated circuit (IC) 120. It is appreciated by those of ordinary skill in the art that the exact configuration of the tag assembly 100 illustrated is merely exemplary and other tag designs may be employed without departing from the scope of the invention.

The antenna 220 enables the RF-responsive element to absorb energy sufficient to power the IC chip 120 and thereby provide the response to be detected. Thus, the characteristics of the antenna 220 must be matched to the system 10 in which it is incorporated.

To facilitate the interrogation of the RFID tagged articles 150, and the receipt of information from those tags 100, the present invention includes an antenna 220 that may be adapted to optimally operate in various environments, especially considering retail environments where articles are stored and/or displayed in a shelved manner. The antenna 220 of the present invention preferably functions in proximity to a variety of types of shelving materials. The particular design required to optimize performance will depend on the operating frequency selected for the antenna 220. It is also important that the input impedance of the selected IC chip 120 match the impedance of the antenna 220 for maximum energy transfer.

As illustrated in FIG. 1, the interrogation assembly 200 contains the RFID reader 210. The reader 210, is adapted to interrogate an RFID tag 100 to obtain information therefrom in a manner known in the art. The RFID reader 210 may be wirelessly connected to the processor 300 to interrogate the tag assemblies 100. A number of manufacturers make RFID readers that can read a variety of different tags. Any commercially available reader 210 now known or subsequently developed, may be used with an appropriately designed antenna 220 as the interrogation assembly 200.

Because the RFID reader 210 and the antenna 220 described herein must work together to interrogate items of interest successfully, the particular antenna design to be implemented will depend on the interrogation frequency (and perhaps other features) of the RFID reader 210. Thus, specific statements of universally acceptable antenna system design parameters are very difficult to make, especially considering the myriad applications for the RFID space monitoring and asset inventory system 10.

The RFID space monitoring and asset inventory system 10 may operate at any suitable interrogation frequency and with suitable changes in antenna design, this invention may be applied to a wide range of frequencies and applications. The interrogation amplitude is preferably low enough that magnetic media, commercial (non-hardened) semiconductor devices (including memory devices), and other electronic apparatus operating outside this band will not be adversely affected. The system preferably complies with all applicable FCC and European agency electromagnetic emission regulations.

As seen in FIG. 1, the antenna 220 transmits an interrogation signal 205, which may be selected within certain known frequency bands that are preferred because they do not interfere with other applications, and because they comply with applicable government regulations. When the tag assembly 100 receives an interrogation signal 205, it transmits its own response signal 206 that is received by the antenna 220 and transmitted to the reader 210, where it can be used by the processor 300. The processor 300 decodes the response, identifies the tag (typically based on information stored within the CPU 310 or other memory device, not shown), and takes action based on the data received.

Various modifications of the illustrated system are known to those of skill in the art including, for example, using multiple antennas 220 in conjunction with the reader 210 in lieu of the single antenna configuration of the interrogation source 200 that is illustrated. Using multiple antennas 220 is useful in providing even more coverage of the space 160 being interrogated in those applications requiring more precision in taking attendance within the defined space or involving high valued inventory items or to achieve an increased frequency of interrogations.

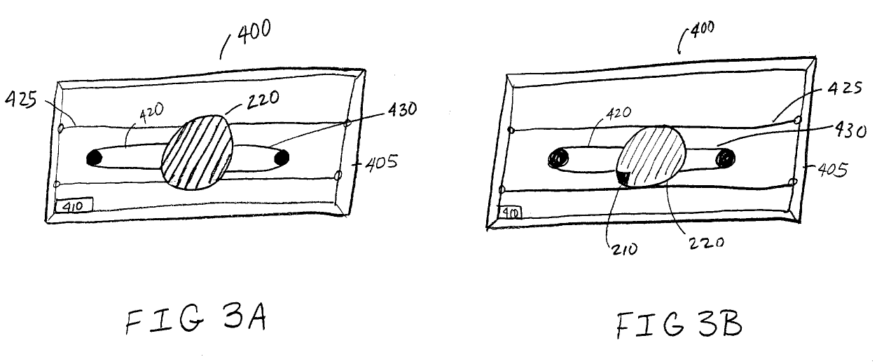

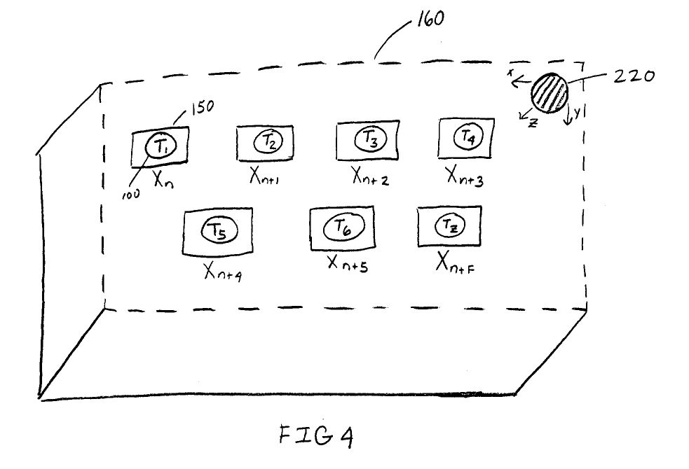

An exemplary antenna moving means 400 is shown in FIG. 3. Exemplary moving means are provided merely for the sake of disclosure because it should be appreciated that any conceivable moving means that can provide controlled three dimensional spatial mobility for antenna 220 to consistently interrogate tagged articles 150 (FIG. 4), may be used without departing from the scope of the invention. However, for the purposes of this disclosure, the following mechanized means will suffice as a preferred embodiment.

As illustrated, antenna moving means 400 (FIGS. 3A & B) has a structural support 405 which can be made of any suitable material such as metal, wood, plastic, and/or any combination thereof. The structural support 405 is adapted to move the antenna 220 about the tagged articles 150 in a manner such that it may be easily moved latitudinally, longitudinally, vertically and through any axis of patch, roll or yaw and/or in any combination of these motions. A belt 430 and pulley 420 system is illustrated as a sample means of carrying out such movement. A prime mover 410 (e.g., electric motor, waterwheel, windpower, solar power means, etc.) provides movement forces to cause the appropriate antenna 220 movement via said belts 430 and pulleys 420.

A preferred design of the present invention would be to have the antenna 220 move around the tagged articles 150 within the defined space 160. FIG. 4 pictorially illustrates the antenna 220 adapted to mechanically move through three spatial dimensions, x, y, and z (denoted with arrows) about tagged articles 150 within the defined space 160. Each tagged article 150 contains a tag assembly 100 having RFID elements as described above regarding FIG. 2.

As shown in FIG. 3A, the antenna 220 is mounted on an antenna moving means 400 and moving continually to interrogate the space 160 to determine the presence of tagged articles 150. Alternatively, as seen in FIG. 3B, the interrogation assembly 200 (comprising both the antenna 220 and the reader 210) may be likewise mounted as a unit on antenna moving means 400. Xₙ denotes the first location of the first tag T₁ 100 of tagged article 150. Each tag assembly 100 may be associated with specific data regarding the article/merchandise and its location Xₙ, X ₙ₊₁, Xₙ₊₂, . . . X_{n+f}, where f numerically designates the final spatial location of the last tagged article 150 containing final tag assembly T_{z}.

The information obtained by the interrogation assembly 200 may be transferred by suitable means, including wireless or wired connection, to the CPU 310 of processor 300 that includes software and a database 312. The software preferably interacts with the database 312 to obtain information about tagged articles 150 T₁ through T_{z}, or to further transmit information about those items to the database 512 of a remote main server 500. The results may be shown to a user on display 520 that may be electronically coupled to main server 500 at a remote location.

Once the reader 210 obtains information from the RFID tagged articles 150, software is used to process and store the information in a manner appropriate to the application. The processor 300 is configured with specific software that is used to interrogate the reader 210 and subsequently interrogate the tagged articles 150. The software sends requests and commands from the processor 300 to the reader 210 to obtain operation parameters and status checks from said reader 210. The software within processor 300 also has safeguards to verify that the commands sent to and from the reader are valid commands or responses.

After the reader 210 reads the RFID tagged article 150, the reader 210 may transmit the item identification information to the processor 300 having software adapted to enable establishments (such as retail businesses) to manage the flow and inventory of merchandise. The software may be adapted to include a database 312 related to patrons, merchandise sales, intricate item information, their status and availability, and the like.

A local database 312 may be used on-site in connection with processor 300, or remote database 512 and/or information processing may be used. Herein, processor 300 may contain a modem 315, or other suitable means of wireless communication for accessing remote databases 512 of a main server 500 within a network. Tags equipped with onboard user accessible memory may be exploited to enhance the performance of the RFID space monitoring and asset inventory system 10 deployed, for example, in a retail environment selling various sorts of items.

In an alternate embodiment, the tag assembly 100 may also include memory component 125 (also FIG. 2) which can also provide significant amounts of user accessible memory, sometimes in the form of read-only memory or write-once memory, but more preferably offering the user the ability to repeatedly update the memory by rewriting its contents from a distance. The amount of memory provided can vary, and influences the size and cost of the integrated circuit portion 120 of an RFID tag assembly 100.

Since other modifications and changes, varied to fit a particular operating requirement and environment, will be apparent to those skilled in the art, the invention is not considered limited to the example chosen for purposes of disclosure, and covers all changes and modifications which do not constitute a departure from the true spirit and scope of the invention.

Having thus described the invention, what is desired to be protected by Letters Patent is presented in the subsequent appended claims. It is to be understood that the present invention is not limited to the embodiments described above, but encompasses any and all embodiments within the scope of the following claims.

What is claimed is:

1. An RF identification space monitoring and asset inventory system for providing electronic surveillance of RF tagged articles, said system comprising:
at least one RFID tag assembly located within a predefined interrogation space comprising an antenna element and an integrated circuit,
an interrogation assembly, said assembly comprising:
an RFID reader, and
antenna means for actively communicating with said tag assembly via RF interrogation signals,
said interrogation assembly configured such that said reader and said antenna means are in electrical communication with one another;
antenna movement means for providing automated, three-dimensional movement of said interrogation assembly, about said predefined interrogation space,
and having motion components adapted and configured to provide three-dimensional, continual movement in a non-coupled sway motion along the x, y, and z axis, resulting in a continuous motion of said interrogation assembly, and
a processor adapted to electronically communicate with said RFID reader; and
wherein said antenna element of said RFID tag assembly is configured to communicate with said antenna means of said interrogation assembly via RF response signals; and
said motion components of said antenna movement means providing movement allowing constant two-way communication with said at least one RFID tag assembly via said RF interrogation signals in conjunction with said RF response signals.

2. The RF identification space monitoring and asset inventory system as in claim 1,
wherein said processor is adapted and configured to control movement of said antenna movement means such that said antenna movement means is movable latitudinally, longitudinally, vertically about said predefined interrogation space through any axis of pitch, roll, or yaw and in any combination of these motions.

3. The RF identification space monitoring and asset inventory system as in claim 2, wherein
said motion components comprise a belt and pulley system.

4. The RF identification space monitoring and asset inventory system as in claim 3, wherein
said processor comprises a central processing unit and a database, said database containing information about said at least one RFID tag element, and
said central processing unit adapted to process data stored within said at least one RFID tag assembly, and
wherein said system further comprises a main server, said main server having a remote modem and a main database, and
wherein said remote modem of said main server is adapted to communicate with said modem of said controller for performing real time mode inventory and security assessments of said at least one RFID tag assemblies.

5. An RF identification space monitoring and asset inventory system as in claim 4,
wherein said system further having remote display and interface means for interfacing with said controller.

6. An RF identification space monitoring and asset inventory system for providing electronic surveillance of RFID tagged articles, said system comprising:
at least one RFID tag assembly located within a predefined interrogation space comprising an antenna element and an integrated circuit,
an RFID reader, and
antenna means for actively communicating with said tag assembly via RF interrogation signals,
said reader and said antenna means are coupled for electrical communication with one another;
antenna movement means for providing automated three-dimensional movement of said antenna means, about said predefined interrogation space, and having motion components adapted and configured to provide three-dimensional, consistent movement in a non-coupled sway motion along the x, y, and z axis, resulting in a continuous motion of said interrogation assembly; and
a processor adapted to electronically communicate with said RFID reader; and
wherein said antenna element of said RFID tag assembly is configured to communicate with said antenna means via RF response signals; and
said motion components of said antenna movement means providing movement allowing constant two-way communication with said at least one RFID tag assembly via said RF interrogation signals in conjunction with said RF response signals.

7. The RF identification space monitoring and asset inventory system as in claim 6,
wherein said processor is adapted and configured to control movement of said antenna movement means such that said antenna movement means is movable latitudinally, longitudinally, vertically about said predefined interrogation space through any axis of pitch, roll, or yaw and in any combination of these motions.

8. The RF identification space monitoring and asset inventory system as in claim 7, wherein
said motion components comprise a belt and pulley system.

9. The RF identification space monitoring and asset inventory system as in claim 8,wherein
said processor comprises a central processing unit and a database, said database containing information about said at least one RFID tag element, and
said central processing unit adapted to process data stored within said at least one RFID tag assembly, and
wherein said system further comprises a main server, said main server having a remote modem and a main database, and
wherein said remote modem of said main server is adapted to communicate with said modem of said controller for performing real time mode inventory and security assessments of said at least one RFID tag assemblies.

10. An RF identification space monitoring and asset inventory system as in claim 9,
wherein said system further having remote display and interface means for interfacing with said controller.
